(19) United States
(12) Patent Application Publication
(10) Pub. No.: US 2003/0203132 A1
(43) Pub. Date: Oct. 30, 2003

(54) Protection of ink prints

(76) Inventor: Lester E. Cornelius, Oyster Bay, NY (US)

Correspondence Address: Charles E. Temko, 22 Marion Road, Westport, CT, 06880, US

(21) Appl. No.: 10/373,815

(22) Filed: Feb. 27, 2003

Related U.S. Application Data
(60) Provisional application No. 60/374,757, filed on Apr. 24, 2002.

(51) Int. Cl. B32B 3/00

(52) U.S. Cl. 428/32.1

(57) ABSTRACT

A means and method for protecting ink prints and other color surfaces, typically dye based prints from the adverse effects of moisture and oxygen, utilising a multilayered applied film including a first layer of polyvinylidene chloride, and a second resin layer overlying the first layer, facing a source of ultraviolet radiation, and including ultraviolet radiation absorbing and reflecting components. The film may be applied to opposite surfaces of a substrate which is then coated with an adhesive for application to the printed surface of the print.

### RELATED APPLICATION

Reference is made to my copending provisional application serial No. 60/374,757 filed Apr. 24, 2002, to which a claim of priority is made.

### BACKGROUND OF THE INVENTION

This invention relates generally to the field of printing of ink images, and more particularly to an improved means and method for protecting printed images against the adulterious effect of moisture and free oxygen, particularly those formed by non-traditional means such as an inkjet printer or similar device.

Most items are given color either by dyes or pigments. Dyes are soluble and can be made to permeate items such as textiles, print media, and plastics. Pigments are generally insoluble and are dispersed into the item to be colored. As a general rule, pigmented colorants have better color stability than dye colorants, but have an accompanying disadvantage in that they tend to be far more costly.

It is generally known that protecting dyes and pigments from ultraviolet radiation increases color fastness. There exist many different ways to protect colorants from ultraviolet radiation, such as ultraviolet absorbers, which convert ultraviolet light into heat, materials that reflect ultraviolet radiation, and additives that reverse some of the damage caused by ultraviolet light, or slow down the degradation caused by ultraviolet radiation.

Colorants, both dyes and pigments, are also affected by other environmental factors such as water vapor and oxygen. It is generally known that placing print media under glass increases color fastness. However, it is not always practical to place glass over many items. Water vapor and free oxygen combine chemically with all colorants. Slowing or preventing that process from happening extends color stability over longer periods of time.

There exist various barrier resins which greatly reduce the transmission of water vapor and oxygen. The two most widely used transparent barrier resins are ethylene vinyl alcohol (EVOH) and poly vinylidene chloride (PVDC). EVOH is a good oxygen barrier in low humidity, but it is not a good water vapor barrier. Water vapor is a gas. Many substances prevent permeation of water on a macroscopic scale, but they are not good in preventing water vapor transmission. An example of this is silicone. Silicone is a good water repellent, but it is not good in slowing water vapor transmission.

PVDC is an excellent water vapor barrier, and oxygen barrier, regardless of ambient humidity. For this reason, PVDC is widely used in food packaging. PVDC, however, is easily degraded by ultraviolet radiation exposure, so that its use is generally limited to applications where there is not very much ultraviolet exposure.

### SUMMARY OF THE INVENTION

Briefly stated, the present invention contemplates the combination of PVDC as a coating layer with an overcoating layer that protects the PVDC from ultraviolet light. The barrier properties of PVDC are reduced if ultraviolet absorbers are added directly to the PVDC. In order to make the PVDC useful over a long period of time in an ultraviolet rich environment, it is necessary to provide good ultraviolet protection in a separate coating layer which is closer to the ultraviolet source.

### DETAILED DESCRIPTION OF THE INVENTION

Combining PVDC with separate ultraviolet protection optimizes a coating system against the three main sources of colorant degradation, namely, ultraviolet radiation, water vapor, and free oxygen. It has been proven to be of particular value as a coating system for dye based inkjet print protection in outdoor applications. It is a generally accepted practice to use only pigment based colorants in outdoor applications due to the greater color stability of pigment based colorants. As has been mentioned, the relative cost of pigmented colorants is quite high. Dye based inks can be used outdoors successfully when the disclosed system is used as an overcoating or laminate. It is to be noted that the use of the present invention is not limited to dye-based ink protection, because it has value in color stability in any color application by blocking ultraviolet radiation, reducing water vapor transmission, as well as reducing oxygen transmission The system is essentially a two coat application, in which the ultraviolet radiation protection is incorporated into the outer layer, that is to say facing the ultraviolet radiation source, while the inner layer which is protected against ultraviolet degradation, prevents the transmission of moisture and free oxygen. The following examples are illustrative, with proportions being by weight. Both coats may be applied by various known techniques, such as flow coating, spray coating, roll coating, curtain coating, and the like.

### EXAMPLE 1

### Inside Layer

PVDC polymer (Dow F 278) in Tetrahydrofuran (solvent) 65%

Toluene (solvent) 35%

Optimum film thickness of this layer is 2 grams per square meter to 6 grams per square meter, resulting in a coating of 3 to 5 microns.

### Ultraviolet Protection Layer (Outer Layer)

Acryloid A 21 (Rohm & Haas) in evaporable solvent 35% solids

Uvitex OB (CIBA GEIGY) 11% by weight based on A 21 solids

Tinuvin 328 (CIBA GEIGY) 8% by weight based on A 21 solids

Tinuvin 745 15% by weight based on Tinuvin 328

BYC 341 (BYC CHEMIE, WALLINGFORD, Conn.) 0.5% based on A 21 solids

Acetylacetone 8% based on total weight of coating solution

diluent toluene or xylene to make 100%.

The above outer layer when applied will normally achieve a nine-ten micron film thickness. While the two layers may be directly applied to the surface to be protected, it is convenient to apply the coating system to a polyester film on one surface thereof, the other surface having a pressure sensitive adhesive, following which the polyester film may be cut to convenient size for application to the inkjet print.

It may be observed that the outer coating is similar to known ultraviolet radiation protection coatings, and includes not only an ultraviolet radiation blocking ingredient, but an optical brightener ingredient which serves to reflect that portion of the ultraviolet radiation which is not absorbed. This protection is not only afforded to the inkprint, but also serves to protect degradation of the poly vinylidene chloride layer as well, so that it can effectively perform its own function of preventing transmission of moisture and oxygen. The outer layer, exemplified as an acrylic coating may also be in the form of other resin coating systems known in the art.

I wish it to be understood that I do not consider the invention to be limited to the precise example set forth in the disclosure, for obvious modifications will occur to those skilled in the art to which the invention pertains.

I claim:

1. An improved inkjet image bearing print comprising a base layer having a surface carrying an ink image; a first overcoat layer of resin material forming a water vapor and oxygen barrier, and a second overcoat layer incorporating an ultraviolet radiation absorbing component superposing said first layer; whereby the passage of ambient moisture and free oxygen to effect the quality of said image is inhibited by said first layer, and said second layer prevents the deterioration of both said inkjet image and said first layer from the effects of ultraviolet radiation.

2. The method of protecting an ink image on a base stratum comprising the steps of:
a) providing a stratum having an ink receiving surface;
b) providing an inkjet image on said surface;
c) applying a layer of poly vinylidene chloride upon said first surface and
d) applying a layer of resin material having an ultraviolet inhibiting component upon said first mentioned layer.

3. A multi layer protective coating for images on a surface comprising: a first layer of polyvinylidene chloride in contact with said surface, and a second layer of resin material incorporating an ultraviolet absorbing component disposed upon said first layer; whereby said first layer inhibits the passage of water vapor and free oxygen to deteriorate said images, and said second layer protects said images and said first layer from ultraviolet radiation.

4. A print in accordance with claim 1, said first overcoat layer comprising a transparent barrier resin selected from the group consisting of ethylene vinyl alcohol and polyvinylidene chloride; and said second overcoat layer comprising an ultraviolet absorber and an optical brightener.
